(19) United States
(12) Patent Application Publication
(10) Pub. No.: US 2012/0201593 A1
(43) Pub. Date: Aug. 9, 2012

(54) ROLLER APPLICATOR FOR MASCARA

(75) Inventor: Romualdo PRIORE, Milano (IT)

(73) Assignee: CHROMAVIS S.p.A., Milano (IT)

(21) Appl. No.: 13/020,665

(22) Filed: Feb. 3, 2011

(51) Int. Cl. A45D 40/26; A61Q 1/10; A45D 34/04

(52) U.S. Cl. 401/122; 401/197; 132/200

(57) ABSTRACT

A roller applicator for mascara including a rod on which a cylindrical roller is mounted formed of porous material able to absorb the fluid mascara by capillary action. Advantageously the roller rotates about the rod.

The present invention relates to a roller applicator for mascara.

Mascara applicators are currently in the form of a rod on which fibres are mounted to form the brush by which the product is withdrawn and deposited on the eyelashes. Mascaras applied by traditional brushes are generally in the form of a cream.

When application of a large product quantity to the eyelashes is not necessary as only a coloured effect is required, applicators able to load only a minimum product quantity onto the brush have to be used, together with a very narrow scraper to further reduce the load.

An object of the present invention is therefore to provide a mascara applicator which enables very fluid formulations (viscosity less then 120 centipoise at 25° C.) to be used to colour eyelashes such as to produce a natural and orderly result.

This and other objects are attained by a mascara applicator in accordance with the technical teachings of the accompanying claims.

Further characteristics and advantages of the invention will be apparent from the description of a preferred but non-exclusive embodiment of the applicator, illustrated by way of non-limiting example in the accompanying drawings, in which:

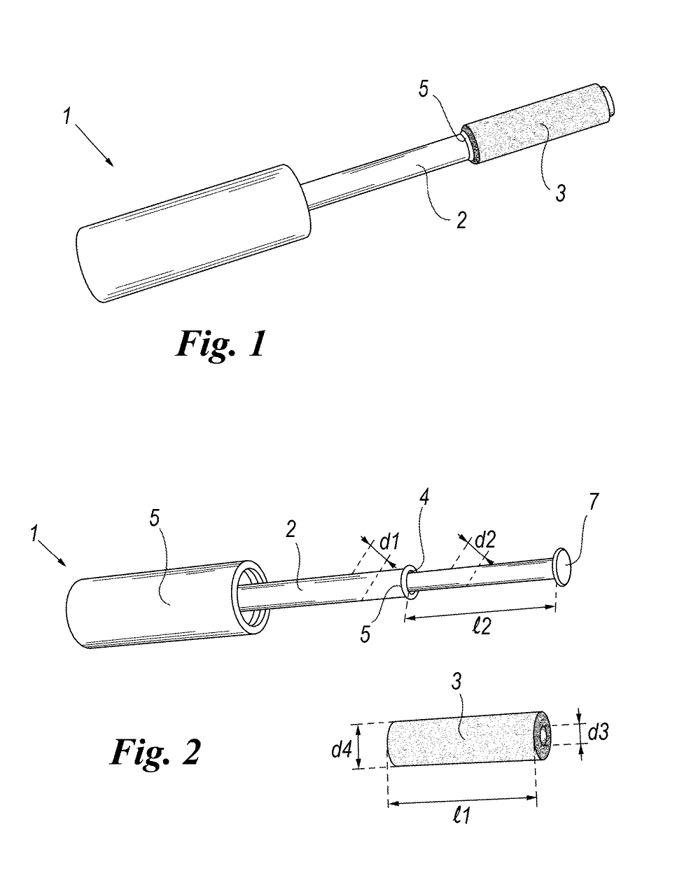

FIG. 1 is a perspective view of an applicator according to the invention, and

FIG. 2 is an exploded perspective view of the applicator of FIG. 1.

With reference to said figures, these show a mascara applicator indicated overall by the reference numeral 1.

It is in the form of a rod 2, on one end of which a roller 3 is mounted formed of a porous material able to absorb fluid or liquid mascara by capillarity. Advantageously the mascara used has a viscosity less than 120 cP, at 25° C. In particular, the roller can be formed of felt, latex, or expanded polystyrene, and advantageously presents a flocked or porous external surface, very suitable for combing eyelashes.

According to an aspect of the invention, the roller rotates on the rod, but could also be fixed. If the roller is able to rotate, mascara application to the eyelashes becomes extremely delicate and enables the eyelashes to be gently combed.

Passing to the structural description of the applicator, it presents a rod with a stem of diameter D1 at a portion to which a stopper/handgrip is fixed. In proximity to the opposite end, the stem is provided with a portion of diameter D2 which is less than D1. The passage zone from the larger to the smaller cross-section therefore presents a step 4, at which a rounded profile 5 is formed.

Alternatively the profile 5 can be defined by a ring mounted on the rod.

At a distance L2 from the step 4 a stop 7 is mounted on the rod and presents a head of diameter greater than D2, such as to secure the roller 3 in its position.

The length L1 of the roller is apt to apply mascara to woman eyelashes. For this scope the length L1 it is comprised between 10 and 40 mm, but preferably it is comprised between 20 and 30 mm.

The roller 3 has an outer diameter D4 of between 5 and 10 mm, preferably 7 mm.

It presents an axial through hole of diameter D3 by which it is mounted on the rod.

By suitably dimensioning the diameter D2 and D3 the roller is able to freely rotate on the rod or to remain rigid therewith.

Advantageously the aforedescribed applicator is used as a stopper for a bottle containing fluid mascara. Advantageously the bottle has a collar positioned at a bottle aperture.

The collar has an opening which diverges outwards from the bottle and has a bore sized on the basis of the roller diameter D4 such as to slightly squeeze the roller when it is extracted from the container, in order to remove excess product, which falls back into the bottle.

A preferred embodiment of the invention has been illustrated, however others can be devised utilizing the same inventive concept.

1. A roller applicator for mascara comprising a rod on which, in an end position, a roller is mounted formed of porous material for absorbing the fluid mascara by capillary, the roller having dimensions for applying mascara to eyelashes.

2. An applicator as claimed in claim 1, wherein the length of the roller is between 10 and 40 mm.

3. An applicator as claimed in claim 1, wherein the diameter of the roller is between 5 to 10 mm.

4. An applicator as claimed in claim 1, wherein said porous material is selected from the group consisting of felt, latex, and expanded polystyrene.

5. An applicator as claimed in claim 1, wherein said roller presents a flocked or porous external surface.

6. An applicator as claimed in claim 1, wherein said roller is rotatably supported by said rod and/or said roller is rigid with said rod.

7. An applicator as claimed in claim 1, wherein said roller is housed in a rod end portion of smaller diameter than the remaining part of the rod.

8. An applicator as claimed in claim 1, wherein at that rod end opposite the roller a closure stopper is provided for a container in which the applicator is to be inserted.

9. An applicator as claimed in claim 1, wherein the roller surface is that of a cylinder having its generators parallel to the axis of said rod.

10. A mascara container presenting a bottle able to contain fluid mascara, a collar positioned at an aperture of said bottle, and an applicator in accordance with claim 1, said collar being sized such as to slightly squeeze the roller when this latter is extracted from the container.

11. A method comprising, applying mascara to eyelashes using the applicator according to claim 1.

12. An applicator as claimed in claim 1, wherein the length of the roller is between 20 and 30 mm.

13. An applicator as claimed in claim 1, wherein the diameter of the roller is between 5 to 7 mm.

14. An applicator as claimed in claim 1, wherein said roller is rotatably supported by said rod

15. An applicator as claimed in claim 1, wherein said roller is rigid with said rod.

16. An applicator as claimed in claim 1, wherein at that rod end opposite the roller a closure stopper is provided for a container in which the applicator is to be inserted, the stopper being threaded.
